(19) United States
(12) Patent Application Publication
(10) Pub. No.: US 2004/0230959 A1
(43) Pub. Date: Nov. 18, 2004

(54) IS NOT OPERATOR

(76) Inventors: Paul A. Vick JR., Seattle, WA (US); Costica Corneliu Barsan, Bellevue, WA (US); Amanda K. Silver, Seattle, WA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/437,822

(22) Filed: May 14, 2003

(51) Int. Cl. G06F 9/45

(52) U.S. Cl. 717/140

(57) ABSTRACT

A system, method and computer-readable medium support the use of a single operator that allows a comparison of two variables to determine if the two variables point to the same location in memory.

### FIELD OF THE INVENTION

The invention relates to programming languages and in particular to an operator within a language that evaluates to “True” when two operands point to different locations in memory.

### BACKGROUND OF THE INVENTION

BASIC, (Beginner's All Purpose Symbolic Instruction Code), was designed to be an easy-to-learn programming language that makes programming easier by providing an intuitive, English-like syntax in which to code. One of the ways in which BASIC eases programming tasks is by not requiring the use of pointer arithmetic. For example, referring now to FIG. 1a, when a BASIC program is executing, a memory buffer 250 (typically a heap) is created in RAM (random access memory) to store application data. When a new object is created, space for the object is allocated on the heap. The new object is represented in FIG. 1a by the box labeled 252, representing a location in memory where the new object is stored. For example, suppose the following BASIC code defining a class x is executed:

Class x

Dim y As Integer

End Class

Class x in this case is defined to contain a member of type “Integer”, which is to say that if the item stored at memory location 252 is a variable of class x, the contents of memory location 252 will comprise an Integer. Suppose now that the following code is executed:

Dim a As x

a=New x( )

The first line of code defines variable a to be of class x while the second line creates a new instance of x 254 on the heap, a pointer to which is stored in variable a 256.

In BASIC, an operator called “Is” allows a comparison of two variables to determine if both variables are pointing to the same memory location. For example, when executing the following code:

Dim a, b As x

a = New x( )
b = New x( )

If a Is b Then

(Perform Z)

End If

Suppose the code represented by the ellipses above has resulted in the situation illustrated in FIG. 1a: variable a 256 is pointing to memory location 254 while variable b 258 is pointing to memory location 260. Hence, Z will not be performed because variables a and b do not point to the same memory location. It will be noted that, the execution of the statement “a Is b” thus determines whether or not the variables a and b point to the same memory location rather than whether or not a is equal to b. In contrast, consider the following code:

Dim a, c As x

a = New x( )
c = New x( )
.
.
.

If a Is c Then

(Perform Z)

End If

Suppose the code represented by the ellipses has resulted in the situation illustrated in FIG. 1b: variable a 256 is pointing to memory location 254 and variable c 262 is also pointing to memory location 256. When the If statement is executed, Z will be performed because variables a 256 and c 262 both point to the same location (location 254) in memory.

Similarly, (for example), if a user wanted to perform Z if the variables a and b do not point to the same memory location, the following code, combining two operators, “Is” and “Not” (a negation of the expression) would be required:

Dim a, b As x

a = New x( )
b = New x( )
.
.
.

If Not (a Is b) Then

(Perform Z)

End If

Such a language construction is ungrammatical, requires more typing and violates the philosophy on which BASIC rests. It would be helpful therefore, if a single more intuitive operator could perform the function that the combination of the two operators Is and Not typically performs.

### SUMMARY OF THE INVENTION

A system, method and computer-readable medium support the use of a single operator that allows a comparison of two variables to determine if the two variables point to different locations in memory, that is, the reverse of the existing “Is” operator in a BASIC programming language or a derivative of BASIC or BASIC-like programming language. In one embodiment of the invention, the memory locations represent objects. The new operator enables a user to determine if the left operand (e.g., a reference type) “is not” the same instance as the reference type listed as the right operand. The use of a single operand for this concept may increase the readability of the programming language.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIGS. 1 a-b are block diagrams of a portion of an execution environment, as may exist for executing BASIC, BASIC-like and BASIC-derivative programs;

FIG. 2 is a block diagram showing an exemplary computing environment in which aspects of the invention may be implemented;

FIG. 3a is a block diagram of an exemplary system comprising a design environment comprising a compiler for generating code for determining whether two variables are pointing to different locations in memory in accordance with one aspect of the invention;

FIG. 3b is a more detailed block diagram of the compiler of FIG. 3a; and

FIG. 4 is a flow diagram of an exemplary method for generating code for determining whether two variables are pointing to different locations in memory in accordance with one aspect of the invention.

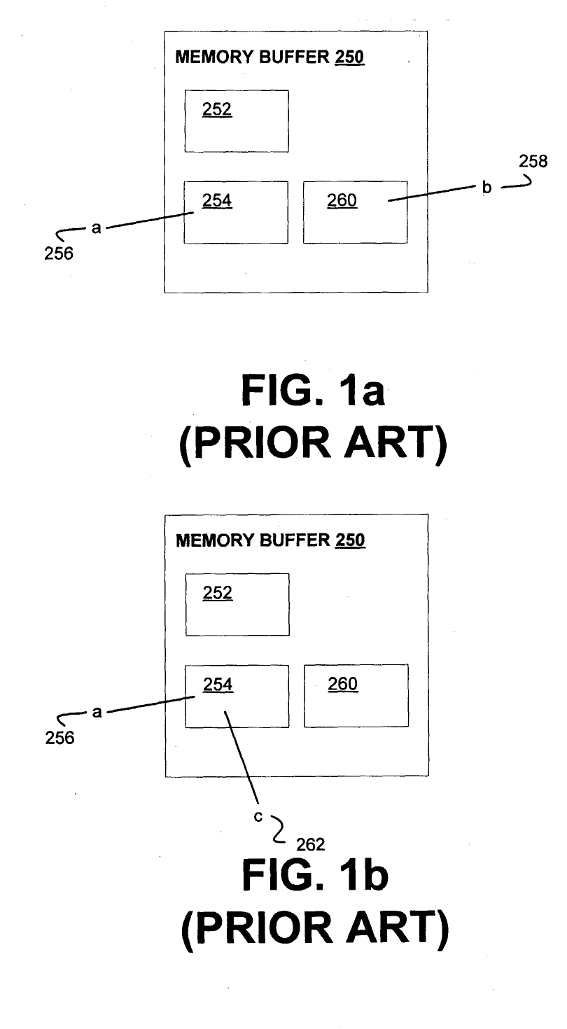

### DETAILED DESCRIPTION OF ILLUSTRATIVE EMBODIMENTS

### Overview

A single operator compares two operands to determine if the two operands point to different memory locations. The memory locations may represent reference types such as objects or instances of a class. For example, in the following code:

Dim x As New MyClass
Dim y As New MyClass( )
x = y
If x Is y Then

Perform (Z)

Where Z represents code to continue program execution. In this case, “x Is y” evaluates to True, because both variables point to the same location in memory. In the example, x and y refer to the same instance of class MyClass. Hence, the program code represented by Z would be performed.

Now consider the following code:

Dim x As New MyClass
Dim y As New MyClass( )
If x Is y Then

Perform (Z)

In this case, “x Is y” evaluates to False, because although both variables are of the same class (that is, belong to the same class, MyClass), variable x points to another instance of the class than does y.

Because the Is operator is often used to ensure that a variable has been initialized, the negation of the operator is often used to compare the variable to Nothing. In BASIC, Nothing is a keyword: the value of a variable that has not been initialized or set to point to a particular memory location evaluates to “Nothing”. Hence, the resulting language is often seen:

Sub Foo(ByRef x As ObjectType)

If Not (x Is Nothing) Then

Perform Z

End If

End Sub,

which is to say, perform Z if x points to an object stored in memory.

In accordance with one embodiment of the invention, the above statement “If Not (x Is Nothing)” which combines the use of two operators, “Is” and “Not”, may be replaced with a single operator. The keyword for the single operator may be “IsNot”, “is_not” or any other suitable keyword which reasonably conveys the concept of “is not”.

### Exemplary Computing Environment

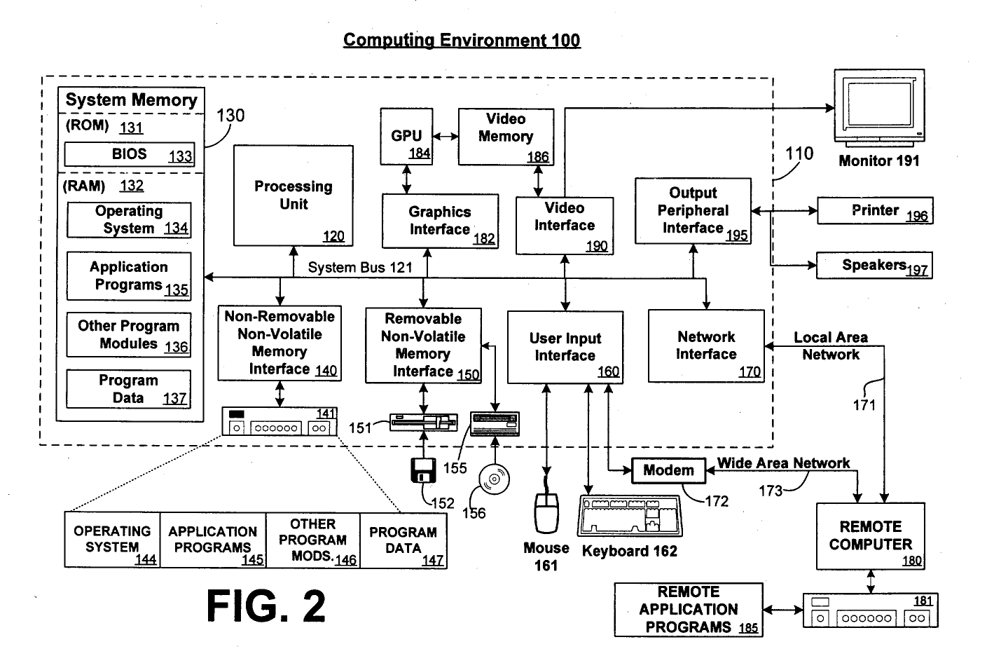

FIG. 2 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 2 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 2, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2 provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

### System and Method for Performing an Object Non-Equivalence Comparison

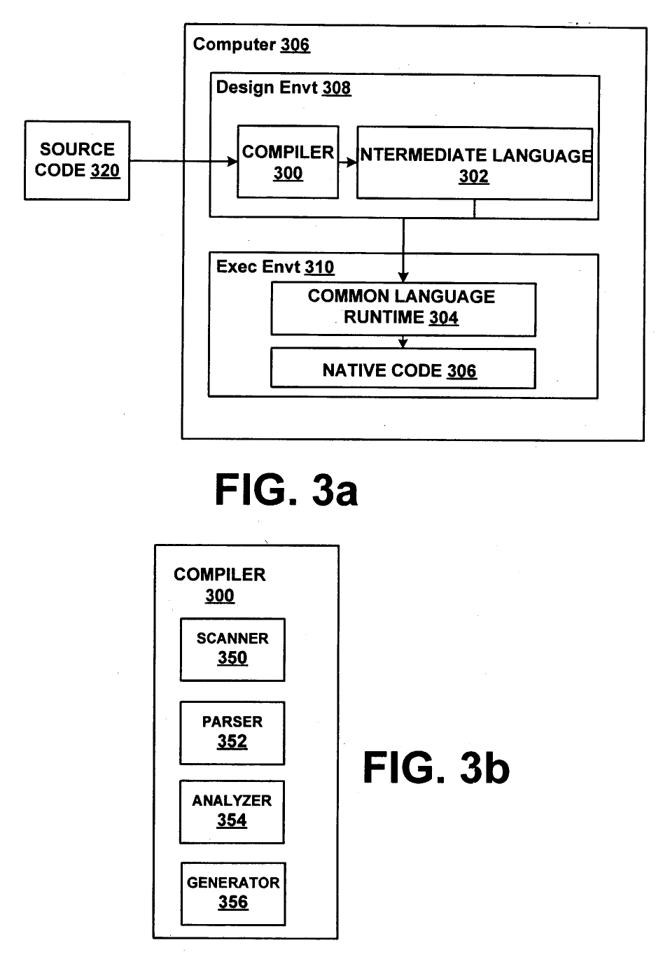

FIG. 3 is a block diagram of a system for determining if two operands point to different locations in memory in accordance with one embodiment of the invention. In FIG. 3 computer 306 represents a computer such as but not limited to a user or development computer on which BASIC applications, BASIC-like applications and BASIC-derivative applications (including but not limited to MICROSOFT VISUAL BASIC, REAL BASIC and the like) may be developed and run. It will be understood that computer 306 may also represent one or more computers. For example, an application may be developed and/or tested on one computer and then installed and run on one or more other computers. The application may be created from source code 320 using a design environment (DE) 308 and may be run in execution environment 310. A design environment may include one or more compilers, here represented by compiler 300, one or more design tools (not shown), an editor (not shown) and the like. One such design environment may be MICROSOFT VISUAL BASIC .NET, BORLAND DELPHI or the like. A design environment 308 may generate from source code 320 executable code capable of being run in an execution environment or may generate an intermediate form of code 302 that is interpreted or compiled again and run by an execution environment such as execution environment 310. An execution environment may include elements required in order to run the compilation produced by the design environment from the source code 320. The execution environment may include elements that produce native code 306 from a non-device-specific intermediate language code 302. The development and execution environments may in addition include various class libraries (not shown). Execution environment 310 may, for example, represent MICROSOFT COMMON LANGUAGE RUNTIME .NET or JAVA SDK or SWING, for example. The application executable may be loaded, along with shared class libraries and execution environment 310, onto one or more computers (not shown) and run.

Referring now to FIG. 3b, compiler 300 may represent a BASIC compiler or interpreter or a compiler or interpreter for a BASIC-like or BASIC-derivative language such as but not limited to MICROSOFT VISUAL BASIC, BORLAND DELPHI or REAL BASIC supporting an operator that evaluates to true if two operands associated with the operator point to different locations in memory and may include the following components: a scanner 350, a parser 352, an analyzer 354 and an executable-generator 356.

The scanner 350 may scan the text of the source code, breaking the statements in the source code into keywords, literal values, whitespace, punctuation, new line indicators and comments. If the keyword representing the single operator that evaluates to true if two operands associated with the operator point to different locations in memory is found, the keyword is recognized. If the keyword is not correctly represented, an error message may be generated.

The parser 352 may parse the scanned text of the source code. If the keyword representing the single operator that evaluates to true if two operands associated with the operator point to different locations in memory is found, the parser may recognize that the keyword must be preceded and followed by an operand. If the keyword is not preceded by and followed by an operand, an error message may be generated. If the operands do not evaluate to reference types, an error message may be generated.

The analyzer 354 may evaluate or understand the parsed statement. For example, a statement including the keyword that evaluates to true if two operands associated with the operator point to different locations in memory may be evaluated to determine if the statement makes sense within the programming language. The analyzer 354 may recognize that the operator that evaluates to true if two operands associated with the operator point to different locations in memory requires operands that are capable of being pointers to a class in the heap. For example, if the keyword for the operator is “IsNot” and the statement “If b IsNot 5” is evaluated, an error message may be generated because “5” is an integer, and so is not capable of being a pointer to a location in memory.

The generator 356 may generate executable code from the analyzed statement, the executable code upon execution, being capable of determining whether two operands are pointing to the same location in memory.

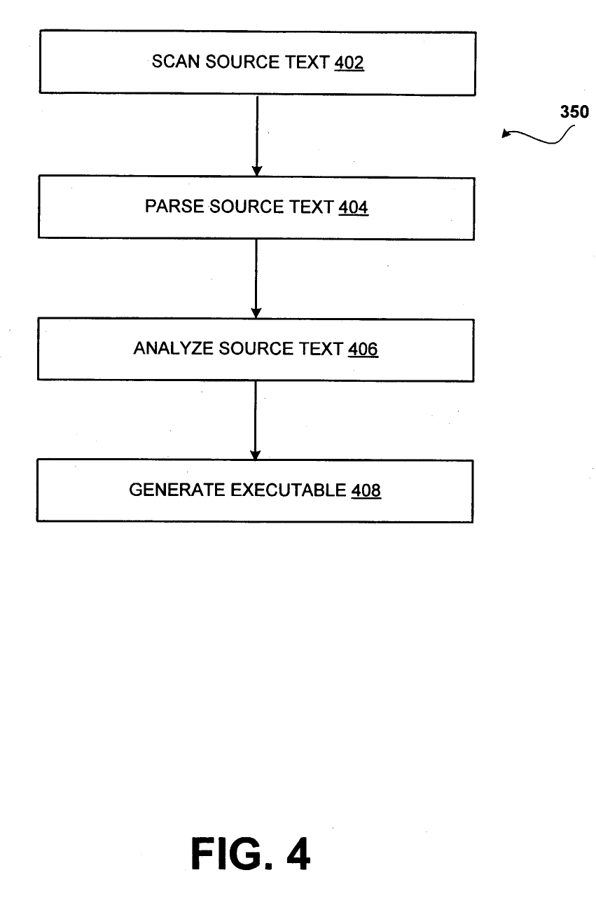

FIG. 4 is a flow diagram of an exemplary method 400 for determining whether two operands associated with an operator are pointing to difference locations in memory in accordance with one embodiment of the invention.

At step 402 the text of the source code is received and scanned. The statements in the source code are broken apart into keywords, literals, whitespace, punctuation, new line indicators and comments. If the keyword representing the single operator that evaluates to true if two operands associated with the operator point to different locations in memory is found, the keyword is recognized. If, for example, the VB statement:

If b IsNot Nothing

is scanned, “If”, “b” “IsNot” and “Nothing” are recognized as words. Keywords such as “If” (the beginning of an if-then statement) and “Nothing” (representing a value to which a pointer is set when the pointer is not pointing to anything in memory) are recognized. “b” is recognized as a variable name and “IsNot” is recognized as an operator. If punctuation were present, the punctuation would be recognized as such. It will be recognized that although in the example, the operator is designated as “IsNot”, the invention is not so limited. Any suitable case sensitive or case insensitive tag for the operator is contemplated by the invention, such as but not limited to “Is_Not”, “isnot”, “Isnot”, “Is_Not”, “is_not” and so on.

At step 404 the statement is parsed. If the keyword representing the single operator that evaluates to true if two operands associated with the operator point to different locations in memory is found, it is recognized that the keyword must be preceded and followed by an operand. For example, when the statement:

“If b IsNot Nothing” is parsed, it is recognized that the keyword “If” should be followed by an expression. In the exemplary statement “If b IsNot Nothing”, keyword “If” is followed by expression “b IsNot Nothing” and an indicator is set to look for an “end if” statement. Had this not been the case, an error message may have been generated. When the operator “IsNot” is parsed, the parser checks that the “IsNot” operator is preceded and followed by an expression or variable that represents a class. The operand in one embodiment of the invention, may be something that results in a pointer to the heap, therefore, or something that evaluates thereto. In this case, “b” and “Nothing” are valid expressions.

At step 406, the statement is evaluated or understood. For example, the statement “If b IsNot Nothing” is evaluated to determine if the statement makes sense within the programming language. In the example, the meaning of the statement is understood as “If the variable b does not point to a location in memory”. “IsNot” is recognized as an operator that requires two expressions capable of being pointers to a class in the heap. For example, if the statement “If b IsNot 5” is evaluated, an error message may be generated because “5” is an integer, not a pointer.

At step 408, executable is generated. In one embodiment of the invention, the executable generated is a machine-independent intermediate code, such as MICROSOFT Intermediate Language or Common Intermediate Language, although native (machine dependent) language or byte code may alternatively or additionally be generated.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed:

1. A system for determining if two operands point to different locations in memory, the system comprising:
a compiler for receiving source code and generating executable code from the source code, the source code comprising an expression comprising an operator associated with a first operand and a second operand, the expression evaluating to true when the first operand and the second operand point to different memory locations.

2. The system of claim 1, wherein the compiler is a BASIC-derived programming language compiler.

3. The system of claim 1, wherein the operator is IsNot.

4. The system of claim 1, wherein the compiler comprises a scanner, a parser, an analyzer and an executable-generator.

5. The system of claim 4, wherein the source code comprises at least one statement, and the statement comprises a keyword representing the operator, the keyword recognized by the scanner.

6. The system of claim 5, wherein the parser receives the scanned source code from the scanner and determines if the operator is preceded by and followed by an operand.

7. The system of claim 6, wherein in response to determining that the operator is not preceded by and followed by an operand, an error message is generated.

8. The system of claim 6, wherein the parsed source code is received by the analyzer, the analyzer evaluating the parsed code to determine if the preceding operand evaluates to a pointer.

9. The system of claim 8, wherein an error message is generated in response to the parser determining that the preceding operand is not a pointer.

10. The system of claim 8, wherein the parsed source code is received by the analyzer, the analyzer evaluating the parsed code to determine if the following operand evaluates to a pointer.

11. The system of claim 10, wherein an error message is generated in response to the parser determining that the following operand is not a pointer.

12. The system of claim 10, wherein the generator receives the analyzed source code from the analyzer and generates executable code from the analyzed code for determining if the first operand and the second operand point to different memory locations.

13. The system of claim 12, wherein the executable code is executed and returns a value of true if the first operand and the second operand point to different memory locations and returns a value of false if the first operand and the second operand point to the same memory location.

14. The system of claim 12, wherein the generated executable code is a non-device-specific intermediate code, capable of being executed by the execution environment.

15. A method for producing executable code for performing an object non-equivalence comparison comprising:
receiving source code comprising at least one statement comprising a keyword representing a logical operator, a first operand preceding the keyword and a second operand following the keyword; and
generating from the source code, executable code for evaluating the statement to true if the first operand and the second operand point to different locations in memory and to false if the first operand and the second operand point to the same locations in memory.

16. The method of claim 15, further comprising:
scanning the source code to recognize the keyword.

17. The method of claim 16, further comprising:
parsing the scanned source code to determine that the keyword is preceded by a first operand that represents a class and followed by a second operand that represents a class.

18. The method of claim 17, further comprising:
evaluating the parsed source code to determine that the first operand and second operand are pointers.

19. The method of claim 18, wherein executable code for performing an object non-equivalence comparison is generated from the evaluated code.

20. The method of claim 15 wherein the source code is BASIC code.

21. A computer-readable medium comprising computer-executable instructions for:
receiving source code comprising at least one statement comprising a keyword representing a logical operator, and a first operand and a second operand; and
generating from the source code, executable code for the at least one statement, the executable code evaluating to true when the first operand points to a first location in memory and the second operand points to a second location in memory that is different from the first location in memory, the at least one statement evaluating to false when the first operand and the second operand point to the same location in memory.

22. The computer-readable medium of claim 21, comprising further instructions for:
scanning the source code to recognize the keyword.

23. The computer-readable medium of claim 22, comprising further instructions for:
parsing the scanned source code to determine that the keyword is preceded by a first operand that represents a class and followed by a second operand that represents a class.

24. The computer-readable medium of claim 23, comprising further instructions for:
evaluating the parsed source code to determine that the first operand and second operand are pointers.
